(19) United States
(12) Patent Application Publication
(10) Pub. No.: US 2012/0204228 A1
(43) Pub. Date: Aug. 9, 2012

(54) METHODS FOR HOSTING DATA ON A GROUP OF NETWORKED HOSTS

(76) Inventor: Howard Fluker, Jarreau, LA (US)

(21) Appl. No.: 13/450,391

(22) Filed: Apr. 18, 2012

(51) Int. Cl. G06F 15/173; G06F 21/00

(52) U.S. Cl. 726/3; 709/225

(57) ABSTRACT

A method for hosting data on an interoperable, related group of networked hosts organized in a tree structure including descendants associated with ancestors, each host independently accessible by network connected client computers, the method including hosting ancestor data on an ancestor host, including genus content related to a genus subject matter, hosting descendant data on a descendant host including species content related to subject matter defining a species within the genus subject matter. Some examples further include incorporating at least a portion of the species content into the ancestor data, connecting the ancestor host in data communication to a client computer via the computer network, and displaying an ancestor output incorporating a portion of the ancestor data Some examples may additionally or alternatively include allowing the user to access the ancestor user features on the ancestor host in response to entering user authentication data consistent with a descendant user records.

### BACKGROUND

The present disclosure relates generally to methods for hosting data on networked hosts. In particular, methods for hosting data on interoperable, related networked hosts are described.

Known methods for hosting data on networked hosts are not entirely satisfactory for the range of applications in which they are employed. For example, many existing methods for hosting data on a group of networked hosts do not adequately allow adequate the sharing of data amongst the hosts in an organized manner. For example, many existing methods do not provide a hierarchical structure organizes data shared between ancestors and descendants to define a structured interface to access the data. As a result, using the shared data is often cumbersome, particularly with regard to user-generated content. Further, classifying and segregating the data may also be cumbersome, as the lack of a hierarchical structure provides inadequate information as to how the data hosted by each networked host relates to the data hosted by the other networked hosts. This may cause difficulties for users to expand or narrow their scope as they access the hosted data.

Further, existing methods do not lend themselves to an organized user management system amongst the various sites. In many examples, users must maintain separate accounts on each site in which they desire access. This may prevent users, from effectively using user features that relate to the data shared amongst the hosts.

Thus, there exists a need for methods for hosting data that improve upon and advance the design of known methods by providing hierarchical data and membership sharing characteristics. Examples of new and useful methods relevant to the needs existing in the field are discussed below.

### SUMMARY

The present disclosure is directed to A method for hosting data on an interoperable, related group of networked hosts organised in a tree structure including descendants associated with ancestors, each host independently accessible by network connected client computers, the method including hosting ancestor data on an ancestor host, including genus content related to a genus subject matter, hosting descendant data on a descendant host including species content related to subject matter defining a species within the genus subject matter. Some examples further include incorporating at least a portion of the species content into the ancestor data, connecting the ancestor host in data communication to a client computer via the computer network, and displaying an ancestor output incorporating a portion of the ancestor data. Some examples may additionally or alternatively include allowing the user to access the ancestor user features on the ancestor host in response to entering user authentication data consistent with a descendant user records.

### BRIEF DESCRIPTION OF THE DRAWINGS

FIG. 1 is a schematic view of an example of a computer system that may be used to implement the disclosed methods.

FIG. 2 is a flow diagram of a first example of a method for hosting data on a group of networked hosts.

FIG. 3 is a schematic view illustrating example output produced by an example group of networked hosts organized according to the method depicted in FIG. 2.

FIG. 4 illustrates an example use case depicting user manipulation of a client computer connected to hosts included in the group of networked hosts depicted in FIG. 3.

FIG. 5 is an example screenshot depicting an example output produced by a host in the group of networked hosts depicted in FIG. 3.

FIG. 6 is an example screenshot depicting an example output produced by a host in the group of networked hosts depicted in FIG. 3.

FIG. 7A is a schematic view of a first example of a hardware configuration of a group of networked hosts organized according to the method depicted in FIG. 2.

FIG. 7B is a schematic view of a second example of a hardware configuration of a group of networked hosts organized according to the method depicted in FIG. 2.

FIG. 8 is a flow diagram of a second example of a method for hosting data on a group of networked hosts.

### DETAILED DESCRIPTION

The disclosed methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any figure or example.

Various examples of the disclosed methods may be implemented using electronic circuit configured to perform one or more functions. For example, with some embodiments of the invention, the disclosed methods may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

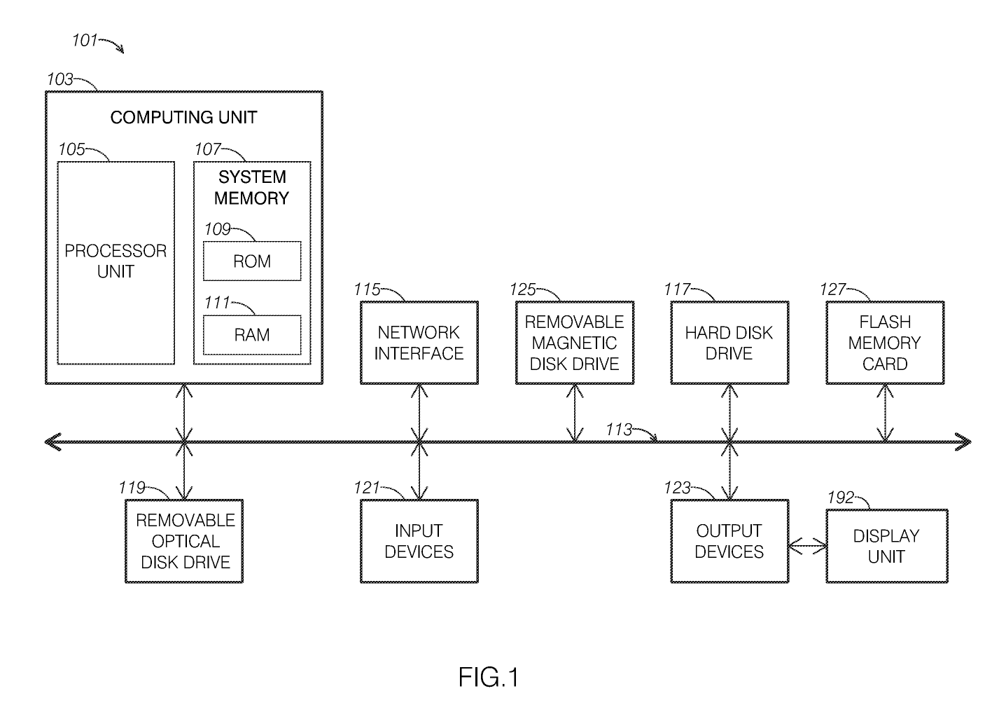

Accordingly, FIG. 1 shows one illustrative example of a computer 101 that can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a display unit, which may include a monitor display, an integrated display, and/or a television, a printer, a stereo, or speakers.

Still further, computing unit 103 will be directly or indirectly connected to one or more network interfaces 115 for communicating with a network. This type of network interface 115, also sometimes referred to as a network adapter or network interface card (NIC), translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

it should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or IPHONE® or Droid® brand smartphone available from Apple, Inc. of Cupertino, Calif. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone.” As known in the art, this type of telephone communicates through a wireless network using radio frequency transmissions. In addition to simple communication functionality, “smart phone” may also provide a user with one or more data management functions, such as sending, receiving and viewing electronic messages (e.g., electronic mail messages, SMS text messages, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

With reference to FIGS. 1-7B, a first example of a method for hosting data on an interoperable, related group of networked hosts organised in a tree structure including descendants associated with ancestors, method 200, will now be described. Method 200 includes hosting ancestor data on an ancestor host at step 204, hosting descendant data on a descendant host at step 208, incorporating an incorporated portion of the descendant data in the ancestor data at step 212, connecting the ancestor host in data communication to a client computer via the computer network at step 222, displaying an ancestor output on the client computer at step 226, receiving user entered data entered by a user on the descendant host at step 230, and incorporating automatically the user entered data into the ancestor data at step 234.

Method 200 illustrates an example method of hosting data over a plurality of network hosts, namely interconnected web sites to share data with one another. Stated another way, method 200 manages a group of networked hosts including ancestor hosts including ancestor data relating to a genus subject matter and descendant hosts including descendant data relating to a descendant subject matter.

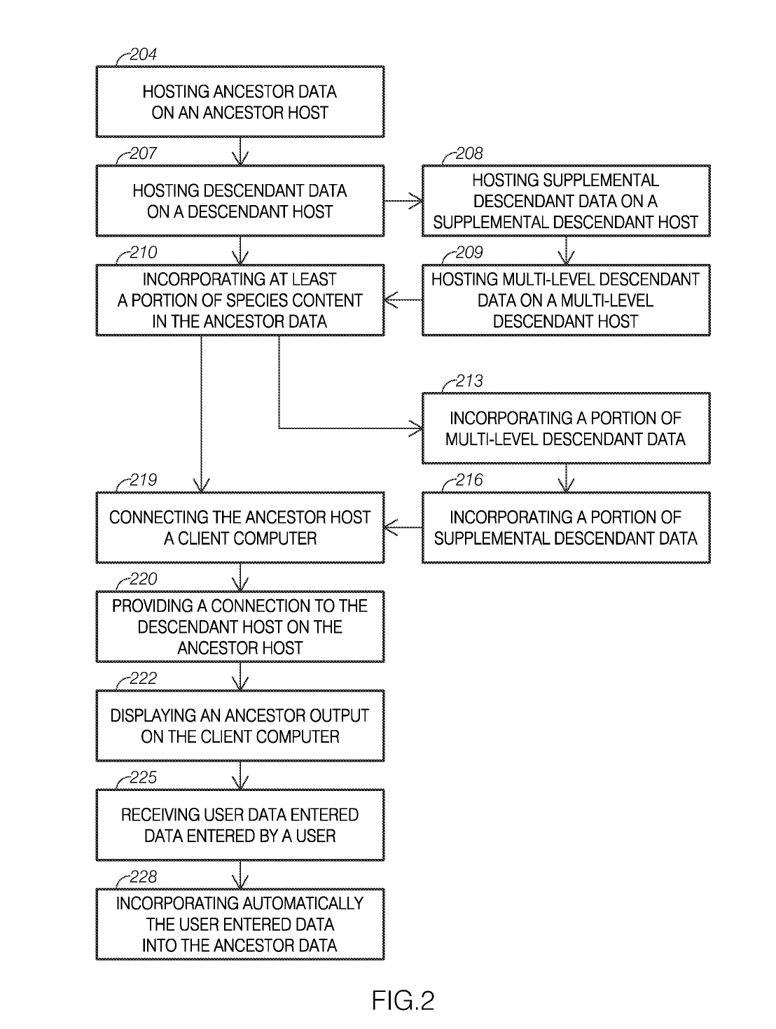

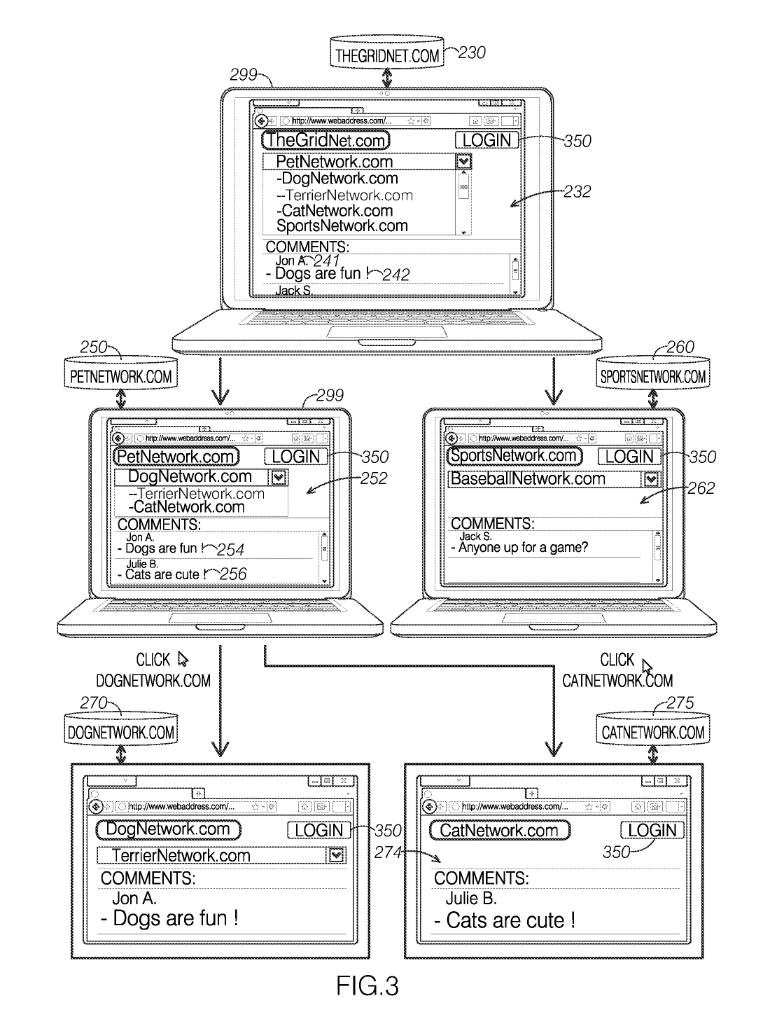

As FIG. 2 illustrates, ancestor data is hosted on an ancestor host at step 204. As an example, FIG. 3 illustrates a client computer 299, similar to computer 101, connected to an example ancestor host, root host 230. Root host 230 is hosted on an ancestor computer system, similar to computer 101, and includes an ancestor network daemon defining an ancestor website daemon. The ancestor network daemon allows one or more client computers to access root host data via a computer network, the root host data related to a genus subject matter.

As FIG. 3 illustrates, the ancestor website daemon displays a web page 232 on a display unit of client computer 299. As FIG. 3 shows, web page 232 is accessible at an internet address resolved from the domain name “TheGridNet.com” and includes genus content related to a genus subject matter that encompasses the wide range of species subject matters encompassed by root host 230's descendants. Because root host 230 is the root of this particular group of hosts, it defines a broad genus subject matter that may encompass nearly any topic, enough certain roots need not be this broad.

As FIG. 3 illustrates, root host 230 is connected to a plurality of descendants and incorporates data from several of them. For example, web page 232 includes a comment 242 from a user 241 that was originally posted on a descendent host.

As FIG. 3 also shows, web page 232 additionally includes a dropbox 234 providing descendant links that direct client computers to descendant addresses that access descendants of root host 230. Dropbox 234 includes a link to every descendant host of root host 230 and represents the descendants in a tiered way that reflects the hierarchical structure in which the networked hosts are grouped. For example, dropbox 234 includes descendant links to: a descendent host 250 accessible at the address “PetNetwork.com,” a supplemental multi-level host 260 accessible at the address SportsNetwork.com, a first multi-level descendant host 270 accessible at the address “DogNetwork.Com,” and a second multi-level descendant host 275 accessible at the address “CatNetwork.com,” Dropbox 234 includes a link to all of its descendants, but this is not required.

As FIG. 2 shows, descendant data is hosted on a descendant host that defines a descendant of the ancestor host. As an example, FIG. 3 illustrates a display produced on a client computer 299 similar to computer 101, connected to an example descendant host, descendent host 250. Descendent host 250 is hosted on a descendant host computer, also similar to computer 101. Descendent host 250 includes a descendant network daemon, namely a descendant web server. As FIG. 3 illustrates, descendent host 250 is configured to display a descendant output, defining a web page 252 on client computer 299. As FIG. 3 shows, we page 252 displays descendant data that includes species content related to a species subject matter defining a niche within the genus subject matter. More precisely, web page 252 displays data corresponding pets, a subset of the broad subject matter encompassed by root host 230's genus subject matter.

As FIG. 2 shows, supplemental descendant data is hosted on a supplemental descendant host at step 208. The supplemental descendant host, supplemental multi-level host 260, defines an additional descendant host on the same hierarchical level as the descendant host, descendent host 250. Any number of hosts may be connected at the same hierarchical level as descendent host 250; there is no limit to the number of supplemental descendant hosts on a hierarchical level, but they should relate to a subject matter that defines subset of the data defined by the genus subject matter.

As FIG. 2 shows, multi-level descendant data is hosted on a multi-level descendant host at step 209. FIG. 3 illustrates two examples of such multi-level descendant hosts, first multi-level descendant host 270 and second multi-level descendant host 275. Each of these multi-level descendant hosts includes one intervening descendant host between them and root host 230, namely descendent host 250. As FIG. 3 illustrates, second multi-level descendant host 275 and first multi-level descendant host 270 each host multi-level descendant data, the multi-level descendant data defines a species encompassed by both root host 230's genus subject matter and descendent host 250's subject matter. As FIG. 3 illustrates, root host 230 defines a general data subject, descendent host 250 narrows the scope to data relating to pets, a species within the general data subject. First multi-level descendant host 270 further narrows the scope, includes a first multi-level descendant page 272 relating to dogs a species within the net subject matter hosted by descendent host 250. Second multi-level descendant host 275 similarly hosts a second multi-level descendant page 274 corresponding to cats.

As FIG. 2 illustrates, an incorporated portion of the species content is incorporated into the ancestor data at step 210. The incorporated portion may include some or all of the species content hosted by the descendant host.

The incorporated portion may be incorporated, for example, by root host 230 receiving and storing a portion of the descendant data hosted by descendent host 250. This may occur automatically or in response to user input. In some examples, hosts may store the hosted data in databases. The stored data may then be included on an output, such as web page 232. In other examples, however, incorporation may not include storing the incorporated data at all. Rather, the retrieved data is applied directly to an output, such as a web page, without ever storing the incorporated data on the descendant host in a permanent form.

FIG. 3 illustrates an example of root host 230 incorporating data from descendent host 250, which in turn incorporates data from its descendants. As FIG. 3 illustrates, descendent host 250 receives data from first multi-level descendant host 270 and second multi-level descendant host 275 over a computer network. Descendent host 250 incorporates this data into its displayed content, as shown on web page 252. More precisely, descendent host 250 received a first descendant comment 254 from first multi-level descendant host 270 and a second descendant comment 256 from second multi-level descendant host 275. Root host 230 incorporates this data from descendent host 250, displayed in part as user comment 242 posted by user 241.

As described above, root host 230 may also directly incorporate data from second multi-level descendant host 275 and first multi-level descendant host 270 without the data ever being communicated to descendent host 253.

Although comments are provided of information that can be incorporated, this disclosure contemplates incorporating any data that may be communicated over a computer network, in one particular example, allowing ancestor hosts to incorporate user data from descendants allows the networked hosts to include a hierarchical user authentication system, wherein users with accounts on descendant hosts may be granted access to user features on the ancestor hosts using the same user authentication data. Some other examples of incorporated data may include forum postings, classified ad postings, video, audio, images, applications (including plugins and webapps), or any other data typically communicated over computer networks.

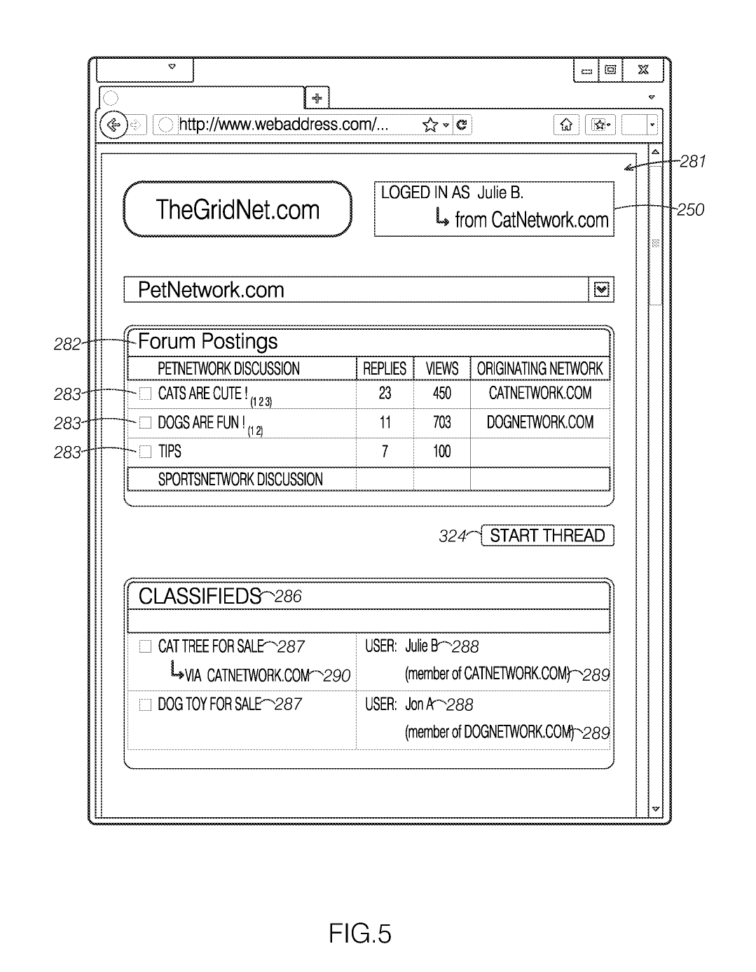

For example, FIG. 5 provides examples of some other example displays produced by root host 230 including data incorporated from descendant hosts. FIG. 5, for example, illustrates an example wherein data contained in a forum posting field is incorporated into ancestor data. FIG. 5 displays a communications page 281, hosted by root host 230 and including a forum 282 that includes forum threads 283 posted by forum users. As FIG. 5 shows, some threads were posted directly on root host 230, such as “Tips,” whereas others were posted on a thread source descendant host 285, such as “DogNetwork.com” or “CatNetwork.com.” As FIG. 5 illustrates, an unlisted source host may indicate that the source of the corresponding thread is the currently viewed site instead of a descendant.

As FIG. 5 shows, forum 282 represents ancestor forum data relating to an ancestor discussion forum hosted on root host 230. As FIG. 5 illustrates, forum 282 also includes forum threads incorporated from descendant forum data on descendant discussion forums hosted by hosted by first multi-level descendant host 270 and second multi-level descendant host 275. This occurs by root host 230 receiving forum data from second multi-level descendant host 275 and first multi-level descendant host 270 including forum posting records with forum posting fields, the forum posting fields corresponding to users'forum postings. This descendant forum data may be incorporated automatically upon a user entering a new post on the descendant discussion forum.

FIG. 5 illustrates an example wherein data contained in a classified ad posting field is incorporated into ancestor data at step 210. FIG. 5 shows that communications page 281 additionally includes a classified ad board 286 including classified ad postings 287 posted by classified ad users 288. As FIG. 5 shows, classified ad board 286 may additionally include a user origin 289 denoting the site on which a particular classified ad user has an account and made the posting. Further, classified ad board 286 may include a post origin 290 denoting where the posting was originally made.

As FIG. 5 shows, classified ad board 286 represents ancestor classified ad data elating to an ancestor classified ad board hosted on root host 230. As FIG. 5 illustrates, classified ad board 286 incorporated some classified ad postings from descendant classified ad data hosted on a descendant classified ad board; in this example, the descendant classified ad data was hosted on second multi-level descendant host 275. This occurs by root host 230 receiving classified ad data from second multi-level descendant host 275 with classified ad records including classified ad posting fields. The classified ad posting fields correspond to users' ad postings. This incorporation may occur automatically upon a user entering a new classified ad on the descendant classified ad board.

Although some of the illustrated features of forum 282 and classified ad board 286 clearly delineate the source of incorporated data, this is not required. Although, forum 282 illustrates this concept in placing clearly marked data from descendant sites alongside each other, this disclosure specifically contemplates including descendant data without designating the origin. Further, each thread may include individual postings within threads on descendant hosts; these individual postings may or may not clearly delineate their source. While this functionality is discussed in connection with the forums, the same logic of elegantly and/or inconspicuously incorporating descendant data into ancestor data may be applied to a number of contexts, including in social media contexts.

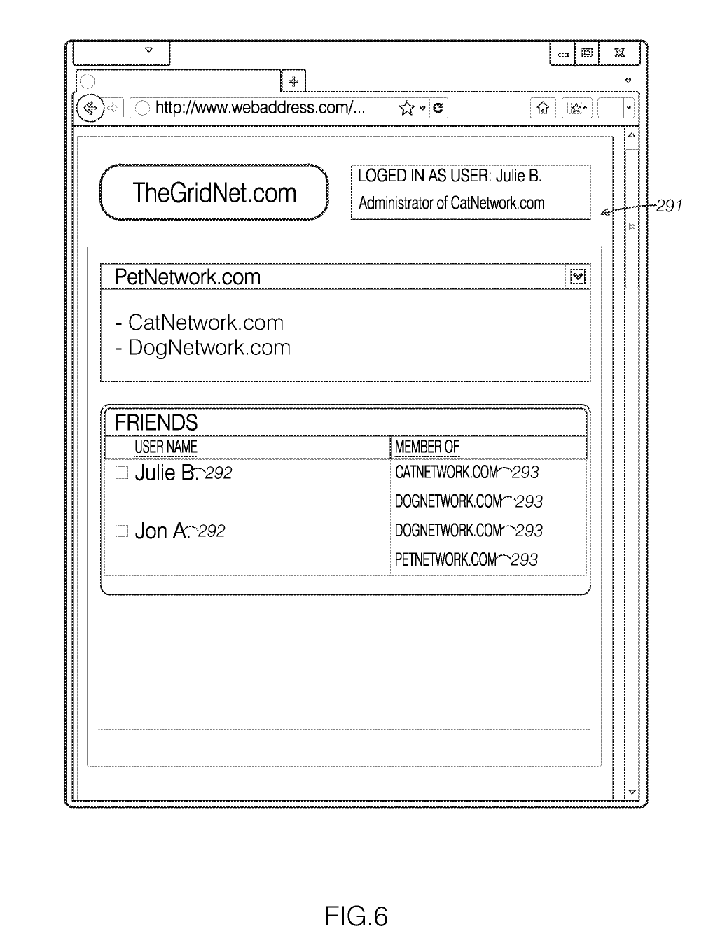

FIG. 6 illustrates another example of incorporated subject matter. FIG. 6 illustrates a social media information page 291 including examples of user accounts 292 corresponding to user “Julie B'”s social media contacts, or “friends.” User accounts 292 are showed along with user originating hosts 293 that define descendant hosts on which the user accounts 292 have explicitly created accounts.

Further, FIG. 6 illustrates examples of user authentication data and membership information on descendant hosts that has been incorporated by root host 230. The users listed in “Julie B.”'s friends each have user accounts 292 that have been incorporated into root host 230's user data, thereby allowing the users with user accounts 292 to log into root host 230 by virtue of maintaining accounts on descendant sites. As FIG. 6 illustrates, users may have accounts on more than one descendant host.

FIG. 6 provides an example display reflecting social media data and of social media features relating to the user “Julie B,” As FIG. 6 shows, the user record corresponding to user “Julie B.” has social media data linking her to “friends,” whom each have an account on at least one of the grouped hosts. This “friend” functionality displays on example social media feature, but other social media feature are contemplated, including a full host of features commonly found on presently understood social media sites. For example, his disclosure specifically contemplates the implementation of other social media features with friends, including friends on ancestor and descendant sites, including sharing photos, sharing videos, sending messages, posting comments on the social media pages of “friends,” scheduling events and inviting “friends,” and playing games with “friends” configured to communicate through the social media features of the networked hosts.

In some examples, descendant hosts may incorporate an incorporated portion of ancestor data, thereby transferring data in the opposite direction. For example, FIG. 3 illustrates a collection of descendant hosts wherein the descendants each incorporate a template 237 from root host 230. In some examples, this incorporation may occur automatically; for example, descendant sites may automatically incorporate relevant subject matter entered on an ancestor host upon entry. Other examples may incorporate any other type of data capable of communication over a computer network, including text, images, video, user account data, and membership information.

By allowing incorporation in both directions, hosts that are not directly linked to one another or that are on different branches of the hierarchical tree defined y the networked group (such as second multi-level descendant host 275 and supplemental multi-level host 260) may share data with one another. This may be particularly useful for sharing data and/or users among hosts that are on different branches on the same genus and are thus somewhat related. For example, a user of second multi-level descendant host 275 may want to view the data hosted by first multi-level descendant host 270, since the data hosted by the two hosts may have similarly interested demographics.

As FIG. 2 illustrates, incorporating at least a portion of the species content into the ancestor data may include incorporating a multi-level incorporated portion of the multi-level descendant data into the ancestor data at step 213.

FIG. 3 illustrates incorporated multi-level descendant data that could have been incorporated one of two ways: incorporating the data to an intervening descendant host and incorporating directly to the root host. In the first way, descendent host 250 receives data from first multi-level descendant host 270 and second multi-level descendant host 275 over a computer network. Descendent host 250 incorporates this data into its displayed content, as shown on web page 252. More precisely, descendent host 250 received a first descendant comment 254 from first multi-level descendant host 270 and a second descendant comment 256 from second multi-level descendant host 275. Root host 230 may then incorporates this data into its genus data and displays it, shown in part in user comment 242 posted by user 241.

As described above, root host 230 may also directly incorporate data from second multi-level descendant host 275 and first multi-level descendant host 270 without the data ever being communicated to descendent host 250.

As FIG. 2 illustrates, a supplemental incorporated portion of the supplemental descendant data is incorporated into the ancestor at step 216. As the supplemental descendant hosts substantially define additional and equivalent descendent hosts, this step operates substantially the same as step 210.

Because many ancestors may incorporate a data from a variety of descendants, many examples segregate, classify, and/or tag data based on their source. FIG. 5 provides many examples of this: forum 282 and classified ad board 286 each include output that denotes the source of the incorporated data.

As FIG. 2 illustrates, the ancestor host is connected to a client computer at step 219. By connecting to one another, allows a client computer and the ancestor host may interact with one another. For example, FIG. 3 illustrates, in part, client computer 299 connected to root host 230 over a computer nets, displaying web page 232 on a display unit of client computer 299. Client computers may similarly connect the descendant hosts as well.

As FIG. 2 shows, art ancestor output is displayed on the client computer at step 222. FIG. 3 shows an example of such an output: web page 232 displayed on client computer 299. This output may, in some examples, include data incorporated from descendants, supplemental descendants, or multi-level descendants. As a result, an ancestor's displayed output will often define a combined output incorporating a selection or all of the species data hosted by the ancestor's descendants and the ancestor's own data.

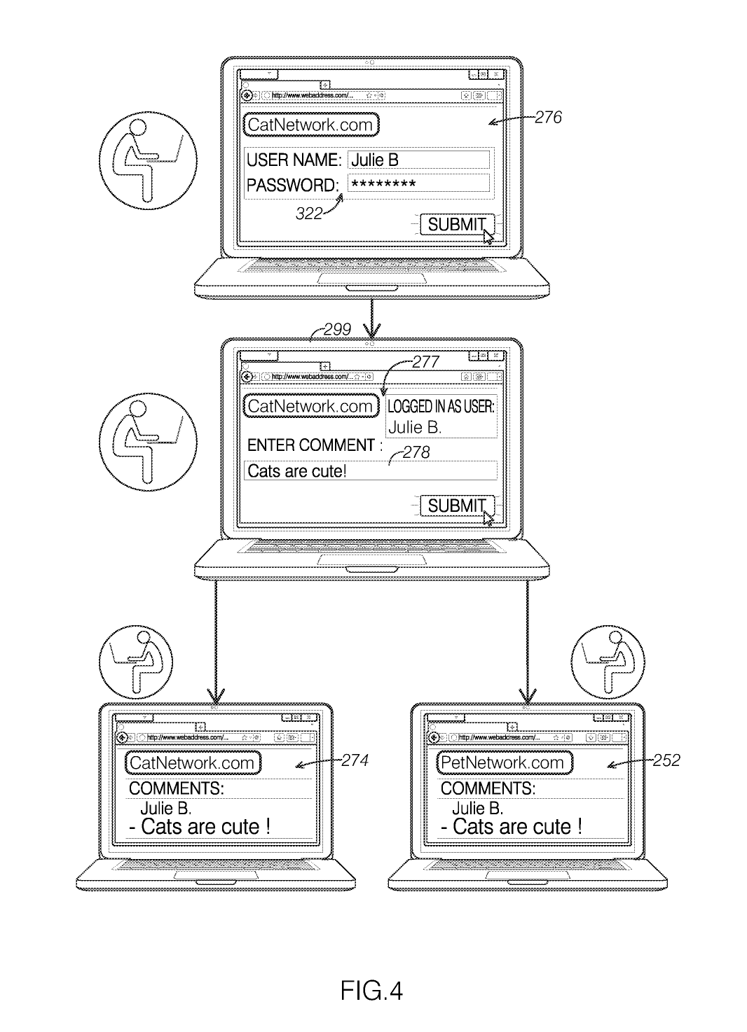

As FIG. 2 shows, user entered data entered by a user is received at step 225. FIG. 4 shows an example. In FIG. 4, a user named “Julie B.” is logged in to second multi-level descendant host 275 and pointed to a data entry page 277. “Julie B.” is able to enter data into a text input 278. “Julie B.” may then finalize her entry by selecting a submission button 279. As FIG. 4 shows, the entered data may then be displayed on second multi-level descendant page 274. As FIG. 4 shows, the entered data may additionally be automatically incorporated to second multi-level descendant host 275's ancestors and displayed on their corresponding pages, such as web page 252.

Some examples may allow users to create new descendant hosts based around the user entered data. For example, descendent host 250 may provide a user connected to a client computer the opportunity to create an additional pet themed descendant site in addition to the dog and cat themed sites hosted by first multi-level descendant host 270 and second multi-level descendant host 275, respectively. In some examples, this may be accomplished automatically, based on a template similar to template 237. In other examples, this may be accomplished by communicating with an administrator of descendent host 250 or not host 230.

As FIG. 2 shows, user entered data is incorporated automatically into the ancestor data at step 228. FIG. 4 illustrates an example of such incorporation. When “Julie B.” enters the data into text input 278, the data is automatically added to web page 252 upon entry. By automatically incorporating data on user entry, method 200 allows hosts to be grouped in a hierarchical structure wherein the ancestors constantly evolve in response to user input entered on its descendants.

There are many uses for such a feature. For example, automatically updating social networks may allow hosts to accommodate segregated, but related, communities that are able to communicate on an ancestor site relating to a genus subject matter that encompasses both of the communities' interests. Descendent host 250, along with web page 252, and its descendants serve as an example of related communities. Descendent host 250 provides a community for pet owners of types. As a result, web page 252 may include a large amount of information that is relevant to cat owners. Second multi-level descendant host 275, however, remedies that problem by providing a community that is entirely directed to cat enthusiasts.

The cat enthusiasts using second multi-level descendant host 275 may often want information about other pets. Therein lies the problem with creating two static sites. When descendent host 250 incorporates information from second multi-level descendant page 274, a cat owner nay be able to view the expanded scope without fearing that she missed any of the information on the cat-centric second multi-level descendant page 274. By automating the process, the cat enthusiast need not rely on any manual updating of the different sites; information may be added to descendent host 250 immediately upon being added on second multi-level descendant host 275. By providing a network of grouped hosts, users may be able to selectively participate in communities of varying scope based on their preferences. Further, by allowing hosts to incorporate user authentication data and membership info, user may be able vary their scope without needing to create a user account at each hierarchical level they choose to access.

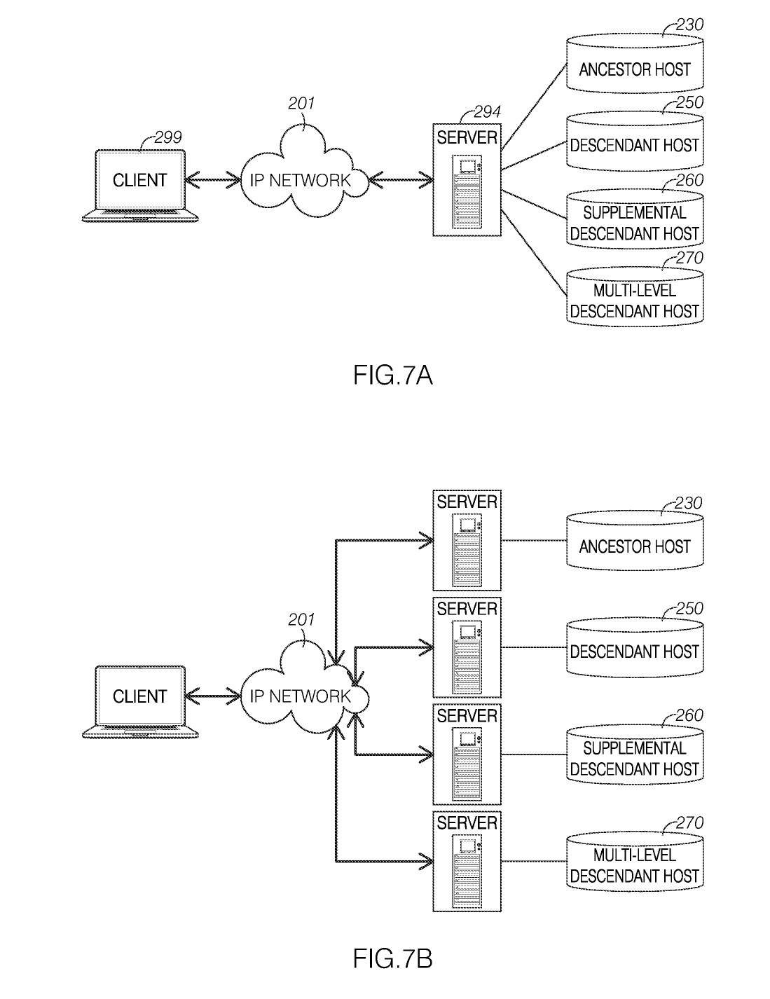

FIGS. 7A and 7B illustrate potential hardware infrastructures used to connect the network hosts. FIG. 7A illustrates a single server configuration, wherein a single computer system, single server 294 hosts of the grouped networked hosts and client computer 299 is configured to connect to single server 294 via IP network 201. In this example, single server 294 hosts a plurality of network daemons each independently accessible by client computer 299. In this configuration, hosts may communicate with one another, for the purposes of incorporating data or otherwise, via IP directly communicating with one another on single server 294.

In some examples, single server 294 is accessible by a plurality of IP addresses, each one pointing to a separate daemon hosted on single server 294. In some examples, each descendant host may be accessed as a subdirectory of the domain defined by a root host.

The type of network daemon defined by the ancestor host and the descendant host need not be the same. For example, the ancestor host that may include a web daemon and database daemon, such as httpd and mysqld, whereas the descendant host includes only a database daemon including different data than the ancestor database. In such an example, the web daemon may be configured to display pages that include data retrieved from the descendant database.

FIG. 7B illustrates a configuration wherein each host is hosted on a distinct server and client computer 299 is configured to connect to each server individually via IP network 201. For example, root host 230 is hosted on root server 295, descendent host 250 is hosted on descendant server 296, supplemental multi-level host 260 is hosted on supplemental host server 297, and first multi-level descendant host 270 is hosted on multi-level descendant host server 298. In this configuration, each server is able to communicate with one another over IP through IP network 201.

Although FIGS. 7A and 7B illustrate two distinct hardware configurations, this disclosure explicitly considers hardware configurations that include both single- and multiple-server configurations for subgroups within a networked group of hosts.

FIG. 3 illustrates, each host may define addresses resolved from domain names. The domain names may describe the subject matter of the data hosted by the corresponding host, and these may provide an easy way to distinguish the ancestor and descendant hosts. For example, descendent host 250 is accessible at an ancestor address resolved from an ancestor domain name, “PetNetwork.com,” which includes a genus-designating string, “Pet,” that describes the genus subject matter. Similarly, second multi-level descendant host 275 is accessible at a descendant address resolved from a descendant domain name, “CatNetwork.com,” which includes species-designating string, “Cat,” that describes the species subject matter and corresponds to a species of the genus described by the genus-designating string.

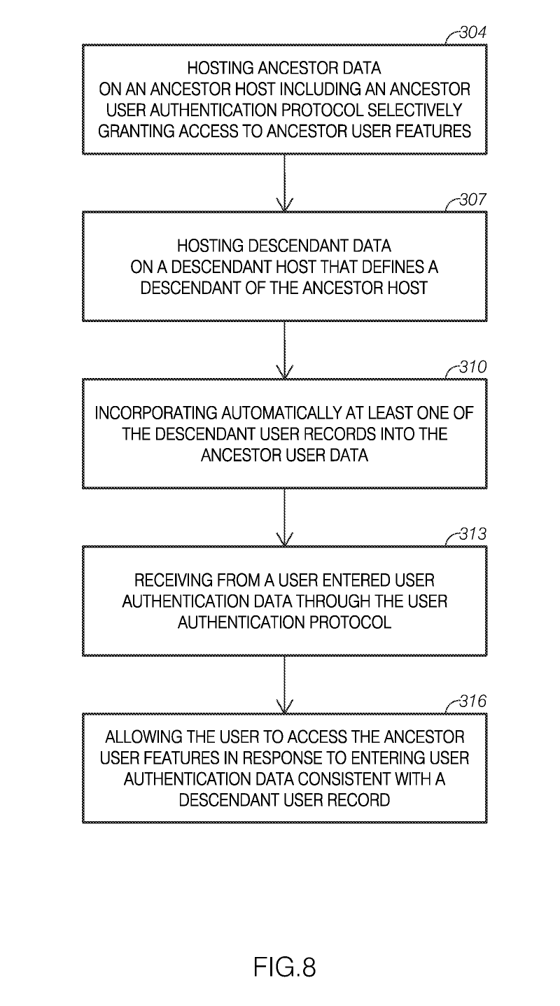

h reference to FIG. 8, a second example of a method for hosting data on an interoperable, related group of networked hosts organized in a tree structure including descendants associated with ancestors, method 300, will now be described. Method 300 includes many similar or identical features to method 200 combined in unique and distinct ways. Thus, for the sake of brevity, each feature of method 300 will not be redundantly explained. Rather, key distinctions between method 300 and method 200 will be described in detail and the reader should reference the discussion above for features substantially similar between the two methods.

As FIG. 8 illustrates, method 300 includes hosting ancestor data on an ancestor host including an ancestor user authentication protocol selectively granting access to ancestor user features at step 304, hosting descendant data on a descendant host that defines a descendant of the ancestor host at step 307, incorporating automatically at least one of the descendant user records into the ancestor user data at step 310, receiving entered user authentication data at step 313, and allowing the user to access the ancestor user features in response to entering user authentication data consistent with a descendant user record at step 316.

FIG. 8 illustrates, ancestor data is hosted on an ancestor host including a user authentication protocol selectively granting access to ancestor user features at step 304. The ancestor data is hosted in a substantially similar manner to the manner described in method 200. The ancestor data hosted at step 304, however, requires users to enter user authentication data to access certain user features. For example, FIG. 5 illustrates an example of an ancestor user feature, “start thread” button 324, that is only accessible when logged in. As FIG. 5 illustrates, user “Julie B.” is logged in and thus is able to access “start thread” button 324. FIG. 4 illustrates another example of a user feature, as is discussed below.

FIG. 4 illustrates a user, “Julie B.,” accessing user features by entering user authentication data into a user authentication protocol. In this example, second multi-level descendant host 275 includes descendant user data including descendant user record corresponding to user “Julie B,” which includes user authentication data corresponding to a user record hosted on second multi-level descendant host 275. In this example, second multi-level descendant host 275 requires user input of user authentication data to access certain user features, which “Julie B.” is able to accomplish by entering appropriate user authentication data into authentication dialog 322. The input user authentication data must be consistent with the user authentication data corresponding to her account to access certain user features, such as text input 278 on data entry page 277. Although this is displayed in the context of a page hosted by second multi-level descendant host 275, this disclosure contemplates extending this same concept to ancestor hosts, wherein entry of data into a similar ancestor user authentication protocol is necessary to access ancestor user features.

As FIG. 6 shows, the authentication protocol may allow users to have accounts granting access to more or fewer user features on corresponding sites. For example, FIG. 4 shows “Julie B.” logged in, where “Julie B.” has an administrator-level account on second multi-level descendant host 275. This may grant her additional user and data management features on the hosts in which she has administrative access.

As FIG. 6 shows individual users may have accounts on multiple hosts, including those that may be descendants or ancestors of one another. As FIG. 6 shows, a user “Jon A.” has accounts on both second multi-level descendant host 275 and descendent host 250.

As FIG. 8 illustrates, descendant data is hosted on a descendant host that defines a descendant of die ancestor host at step 307. Step 307 is substantially similar to step 207. The descendant data hosted at step 307, however, includes one or more user records corresponding to user accounts, each descendant user record including a descendant user authentication field including descendant user authentication data. User authentication data often includes, as a minimum, a username and a password, as displayed in authentication dialog 322. User records may, however, include any information currently associated with internet accounts, such as web and/or social media sites.

As FIG. 8 illustrates, an incorporated descendant user record is incorporated automatically into ancestor user data at step 310. In this example, an ancestor host includes ancestor user data including ancestor user records corresponding to ancestor user accounts, each ancestor user record including an ancestor user authentication field including ancestor user authentication data, in many situations, users may have signed up for accounts on descendant sites without ever creating an account on the corresponding ancestors. As a result, the descendant sites would include their user records, whereas the ancestor site would not.

By incorporating the descendant user data, the ancestor user data may include ancestor user records that correspond to some or all of its descendants' users. This occurs similar to the incorporation described above; all or a portion of the user data hosted by the descendant data is communicated to the ancestor host and included within the ancestor data. This may occur automatically, thereby automatically granting users access to a group of sites by registering for an account on a descendant site.

As FIG. 8 shows, entered user authentication data is received through the user authentication protocol at step 313. In a web context, the user authentication protocol may include a login screen, such as authentication dialog 322 shown in FIG. 4, or an authentication element displayed on a page containing other elements, illustrated by authentication boxes 350 illustrated on each of the pages displayed in FIG. 3.

As FIG. 8 illustrates, the user is allowed to access the ancestor user features in response to entering user authentication data consistent with the incorporated descendant user record at step 316. Because the user authentication data has been incorporated by the ancestor host, the ancestor host recognizes the user authentication data of the descendant user record. As a result, the user of the descendant site may be granted access even if she did not specifically sign up for an account on the ancestor site.

Upon recognizing the user authentication data as a user on the descendant host, the ancestor host may display user features despite the fact that the user does not have an account on the ancestor page. For example, FIG. 6 illustrates that user “Julie B,” does not have an account on “TheGridNet.com,” or root host 230. FIG. 6 illustrates that “Julie. B” does, however, have an account on two descendants of root host 230, first multi-level descendant host 270 and second multi-level descendant host 275. As a result, “Julie B,” may be granted access to user features on root host 230 by entering the user authentication data corresponding to her user record on second multi-level descendant host 275, as displayed by FIG. 5.

Though this examine provides a very simple user authentication model, this disclosure specifically contemplated expanding this concept to the full range of user authentication models commonly used in internet contexts, specifically including, but not limited to, web and/or social media contexts. Other examples may include access to user profiles, access to a contacts or friends list, access to otherwise protected files or media, access to e-mail, shell, or FTP accounts, or other common user-restricted features in internet contexts.

The disclosure above encompasses multiple distinct inventions with independent utility. While each of these inventions has been disclosed in particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the, art pertaining to such inventions. Where the disclosure or subsequently filed claims recite “a” element, “a first” element, or any such equivalent term, the disclosure or claims should he understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A method for hosting data on an interoperable, related group of networked hosts organized in a tree structure including descendants associated with ancestors,each host independently accessible by network connected client computers, the method including:
hosting ancestor data on an ancestor host, wherein:
the ancestor host defines an ancestor network daemon operating on an ancestor computer system connected to a computer network, the ancestor host accessible by client computers via the computer network;
the ancestor data includes genus content related to a genus subject matter; and
the ancestor host allows one or more client computers to access the ancestor data, via the computer network;
hosting descendant data on a descendant host that defines a descendant of the ancestor host; wherein:
the descendant host defines a descendant network daemon operating on a descendant computer system connected to the computer network, the descendant host accessible by client computers via the computer network;
the descendant data including species content related to a species subject matter defining a niche within the genus subject matter; and
the descendant host allows one or more client computers to access the descendant data via the computer network;
incorporating an incorporated portion of the species content into the ancestor data;
connecting the ancestor host in data communication to a client computer via the computer network; and
displaying on a display unit of the client computer an ancestor output including the incorporated portion of the species content.

2. The method of claim 1, wherein incorporating the incorporated portion of the species content into the ancestor data includes incorporating automatically the incorporated portion of the species data.

3. The method of claim 1, further comprising receiving from a user user entered data on the client computer, wherein:
the descendant computer system begins operating the descendant network daemon in response to receiving the user entered data; and
the descendant data includes the user entered data.

4. The method of claim 1, further comprising:
receiving user entered data from a user on the client computer connected to the descendant host, the user entered data corresponding the species subject matter; and
incorporating automatically the user entered data into the ancestor data.

5. The method of claim 1, further comprising providing a connection to the descendant host on the ancestor host.

6. The method of claim 5, wherein:
the ancestor output includes an ancestor website incorporating the descendant data; and
the ancestor website includes a descendant link to a descendant address used by the connected client computer to access the descendant host.

7. The method of claim 1, further comprising hosting a plurality of supplemental descendant hosts, each supplemental descendant host defining a descendant of the ancestor host and hosting supplemental descendant data;
wherein the ancestor data incorporates a supplemental incorporated portion of the supplemental descendant data.

8. The method of claim 1, further comprising hosting a plurality of multi-level descendant hosts, each multi-level descendant host defining a descendant of the descendant host and hosting multi-level descendant data.

9. The method of claim 8, further comprising incorporating automatically a multi-level incorporated portion of the multi-level descendant data into the descendant data,

10. The method of claim 8, wherein the ancestor output includes a list of the multi-level descendant hosts.

11. The method of claim 1, wherein the descendant host and ancestor host are operated on a single computer system.

12. The method of claim 1, wherein:
the ancestor host is accessible at an ancestor address resolved from an ancestor domain name, the ancestor domain name including a genus-designating string that describes the genus subject matter;
the descendant host is accessible at a descendant address resolved from a descendant domain name; and
the descendant domain name includes a species-designating string identifying the Species subject matter, the species-designating string describing a species of the genus described by the genus-designating string.

13. The method of claim 1, herein:
the descendant data includes descendant classified ad data corresponding to a descendant classified ad board including one or more classified a records relating to the species subject matter, each classified ad record including a descendant classified ad posting field including data corresponding to a user ad posting;
the ancestor data includes ancestor classified ad data corresponding to an ancestor classified ad board; and
the data contained in the descendant classified ad posting field is automatically incorporated into the ancestor classified ad data.

14. The method of claim 1, wherein:
the descendant data includes descendant forum data corresponding to a descendant discussion forum including one or more forum posting records relating to the species subject matter, the descendant forum data including a descendant forum posting field including data corresponding to a user forum posting;
the ancestor data includes ancestor forum data corresponding to an ancestor discussion forum; and
the data contained in the descendant forum posting field is automatically incorporated into the ancestor forum data.

15. The method of claim 1, wherein:
the descendant data includes descendent user data corresponding one or more descendant user records corresponding to user accounts on the descendant host, each descendant user record including social media data; and
the ancestor data incorporates at least portion of the descendant user data.

16. A method for hosting data on an interoperable, related group of networked hosts organized in a tree structure including descendants associated with ancestors, each host independently accessible by network connected client computers, the method including:
hosting ancestor data on an ancestor host, wherein:
the ancestor host defines an ancestor network daemon operating on an ancestor computer system connected to the computer network, the ancestor host accessible by client computers via the computer network;
the ancestor data includes genus content related to a genus subject matter; and
the ancestor host allows one or more client computers to access the ancestor data via the computer network;
hosting descendant data on a descendant host, the descendant host defining an descendant of the ancestor host wherein:
the descendant host defines a descendant network daemon operating on a descendant computer system connected to a computer network, the descendant host accessible by client computers via the computer network;
the descendant data includes species content related to a species subject matter defining a niche within the genus subject matter, the descendant data including an incorporated portion of the ancestor data; and
the descendant host allows one or more client computers to access the descendant data via the computer network;
connecting the descendant host in data communication to a first client computer via the computer network; and
displaying on a display unit of the first client computer a descendant output including a portion of the descendant data.

17. The method of claim 16, wherein the descendant data incorporates automatically the incorporated portion of the ancestor data.

18. A method for hosting data on an interoperable, related group of networked hosts organized in a tree structure including descendants associated with ancestors, each host independently accessible by network connected client computers, the method including:
hosting ancestor data on an ancestor host, wherein:
the ancestor host defines an ancestor network daemon operating on an ancestor computer system connected to a computer network, the ancestor host accessible by client computers via the computer network;
the ancestor host includes an ancestor user authentication protocol selectively allowing a user connected by a client computer to access ancestor user features in response to user input of user authentication data; and
the ancestor host allows one or more client computers to access the ancestor data via the computer network;
hosting descendant data on a descendant host that defines a descendant of the ancestor host, wherein:
the descendant host defines a descendant network daemon operating on a descendant computer system connected to the computer network, the descendant host accessible by client computers via the computer network;
the descendant data including descendent user data corresponding one or more descendant user records corresponding to user accounts on the descendant host, each descendant t user record including a descendant user authentication field including descendant user authentication data; and
the descendant host allows one or more client computers to access the descendant data via the computer network;
receiving entered user authentication data on the user authentication protocol; and
allowing the user to access the ancestor user features in response to entering user authentication data consistent with one of the descendant user records.

19. The method of claim 18, wherein:
the ancestor host includes user data including one or more ancestor user records, each record corresponding to an ancestor user account; and
the entered user authentication data is not consistent with any of the ancestor user records.

20. The method of claim 18, wherein the ancestor data includes ancestor user data corresponding to one or more ancestor user accounts, each ancestor user record including an ancestor user authentication field including ancestor user authentication data;
further comprising incorporating automatically at least one of the descendent user records into the ancestor user data.

21. A method for hosting data on an interoperable, related group of networked hosts organized in a tree structure including descendants associated with ancestors, each host independently accessible by network connected client computers, the method including:
hosting ancestor data on an ancestor host, wherein;
the ancestor host defines an ancestor network daemon operating on an ancestor computer system connected to a computer network, the ancestor host accessible by client computers via the computer network;
the ancestor data includes ancestor user data corresponding one or more ancestor user records corresponding to user accounts on the descendant host, each ancestor user record including social media data; and
the ancestor host allows one or more client computers to access the ancestor data via the computer network;
hosting descendant data on a descendant host that defines a descendant of the ancestor host, wherein:
the descendant host defines a descendant network daemon operating on a descendant computer system connected to the computer network, the descendant host accessible by client computers via the computer network;
the descendant data includes descendent user data corresponding one or more descendant user records corresponding to user accounts on the descendant host, each descendant user record including social media data; and
the descendant: host allows one or more client computers to access the descendant data via the computer network;
incorporating an incorporated portion of the social media data into the ancestor data;
connecting the ancestor host in data communication to a client computer via the computer network; and
displaying on a display unit of the client computer an ancestor output including the incorporated portion of the social media data.
